(19) United States
(12) Patent Application Publication
(10) Pub. No.: US 2026/0312874 A1
(43) Pub. Date: Oct. 8, 2026

(54) SYSTEMS AND METHODS FOR USE IN LOCATION IDENTIFICATION FOR NETWORK-BASED DIVISIONS

(71) Applicant: MASTERCARD INTERNATIONAL INCORPORATED, PURCHASE, NY (US)

(72) Inventors: Tim M. Watkins, O'Fallon, MO (US); Robert Wayne Anderson, Eden Prairie, MN (US); Bryan Franke, Blackwell, MO (US); Sachin Kakani, Pune (IN); Santosh Prakash Deshpande, Pune (IN)

(21) Appl. No.: 19/173,486

(22) Filed: Apr. 8, 2025

(51) Int. Cl. H04L 41/12

(52) U.S. Cl. CPC H04L 41/12

(57) ABSTRACT

Systems and methods are provided for identification of computer-based assets in connection with regulatory technologies. One example method includes, in response to a request, searching, by a host computing device, for a physical location based on multiple site codes implicated in the request; summarizing, by the host computing device, the physical location for one or more of the sites codes; and displaying the physical location summary to a user.

### FIELD

The present disclosure generally relates to systems and methods for identification of locations for computer-based assets, which host network-based divisions, in connection with regulatory technologies.

### BACKGROUND

This section provides background information related to the present disclosure which is not necessarily prior art.

In connection with the control, dissemination, etc. of information, regulations are known to be imposed by governments, agencies, companies, etc. to ensure, among other things, security and integrity of the information. The regulations may be specific to types of assets, or locations, whereby reporting is important to evidence satisfaction of the regulations. The reporting, in some instances, may be required down to physical assets, whereby the location of the physical assets may define the applicable regulatory reporting, control, security, or other handling of the information contained in the physical assets.

### DRAWINGS

The drawings described herein are for illustrative purposes only of selected embodiments and not all possible implementations, and are not intended to limit the scope of the present disclosure.

FIG. 1 is a block diagram of an example system of the present disclosure suitable for use in identifying the physical location of programs, applications, etc., which rely on disparately located physical devices;

FIG. 2 is a block diagram of an example computing device, that may be used in the system of FIG. 1; and

FIG. 3 is an example method for identifying physical assets to locations, based on site codes specific to the physical assets, via a site code registry.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Divisions rely on different services to provide functionality. The services, in turn, may reside on various physical assets, in various geographic locations. In this way, virtual divisions, or more generally, applications, which rely on the services, may be unlinked to the underlying physical assets, whereby regulatory reporting, control, etc., may be limited.

Uniquely, the systems and methods herein provide for identification of physical location(s) of physical assets, through site codes that are inherited at least to the services, and divisions. In this manner, regulatory and other reporting is generated, based on the inheritance of physical location(s), to ensure proper compliance with regional limitations on data, services, etc.

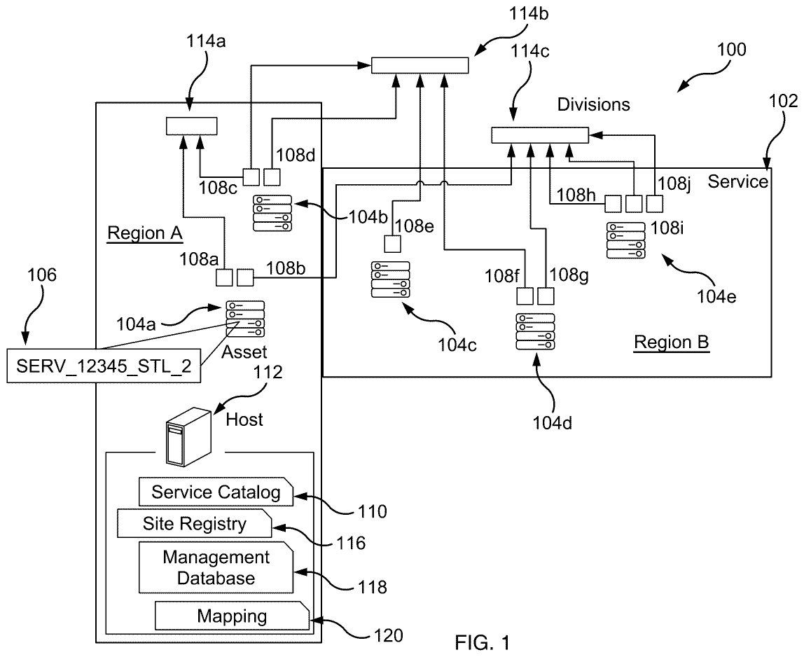

FIG. 1 illustrates an example system 100, in which one or more aspects of the present disclosure may be implemented. Although the system 100 is presented in one arrangement, other embodiments may include systems arranged otherwise within the scope of the present disclosure.

The system 100 generally includes a processing network 102, which, in turn, includes multiple different assets 104a-e, each coupled to one or more networks. The one or more networks may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof.

In this example embodiment, the processing network 102, in general, is configured to coordinate messaging related to account transactions, such as, for example, messaging related to authorization, clearing, settlement, etc., and also, potentially, services in support of, directly or ancillary, to the account transactions, such as, for example, tokenization, fraud scoring, authentication, etc., which may be employed alone or in combination with other related services, in one or more geographic regions.

It should be appreciate that while the illustrated system 100 includes a payment specific network 102 in this embodiment, the system 100 may include a network configured for other purposes in other system embodiment.

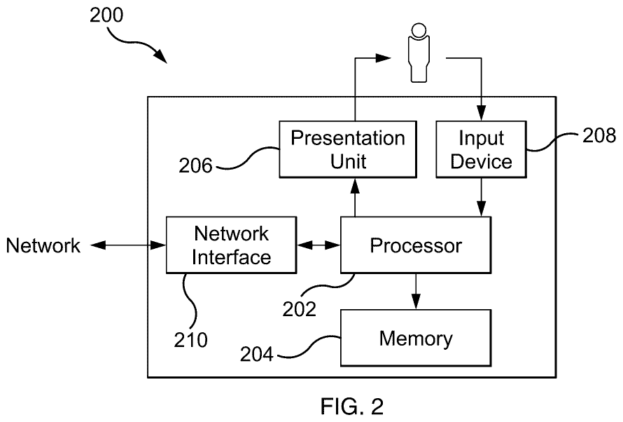

With continued reference to FIG. 1, the assets 104a-e are physical assets (or technical assets), which, in general, include computing devices, such as illustrated in FIG. 2, in whole or in part, as described more below. The computing devices may include servers, etc., which are generally installed and/or located in a specific location (e.g., a server room, a data center, etc.). As such, the physical assets 104a-e are generally not, in this example, mobile computing devices. Each of the assets 104a-e includes an operating system or OS, such as, for example, a WINDOWS, macOS, UNIX, Linux, IOS, Android, ChromeOS, etc., operating system, etc. The operating system is executed by the physical asset 104a-e (e.g., processor thereof, etc.), which, in turn, configures the physical asset 104a-e to manage resources thereof, including memory and processing, etc. In addition, uniquely, in this example embodiment, each of the physical assets 104a-e is physically marked with a site code. The site code is unique to each of the assets 104a-e, whereby no same site code is marked on more than of the one assets 104a-e. The site code may be indicative of the physical location of each of the assets 104a-e, or otherwise. For example, the physical asset 104a may be stamped with a site code tag 106, which includes the site code SERV_12345_STL_2. The site code indicates, in this example, that the asset 104a is a server, which is number 12345 and located in St. Louis, Missouri, in data center 2.

It should be appreciated that a different form of site code may be employed in other examples, and may, in some examples, include limited or no information about the physical location of the assets, and/or may include other information about the assets, etc. (e.g., model, etc.).

The physical assets 104a-e, in turn, are configured to execute various services 108a-j, which are implemented by an operator of the processing network 102 to support the purpose thereof. The services 108a-j are more commonly referred to as applications, which perform operations (such as, for example, transaction processing, security functions, or other business service functions, etc.), or may reference databases, which store data, etc. As shown, the system 100 includes services 108a-j, but another number of services may be include in other embodiments.

In the illustrated embodiment, the services 108a-j are organized into a service catalog 110, which is, generally, a listing of the services 108a-j executed within the processing network 102. The service catalog 110 is stored, in this embodiment, in a host computing device 112. The service catalog 110, for each of the services 108a-j, includes, without limitation, a name, an owner, a description/purpose, an operating location (which may also be referred to as a site ID or site Code) a unique record identifier, a service criticality, a regulated data type, etc.

The services 108a-j, in turn, are implemented and/or combined to form divisions 114a-c, which are offered to customers of the processing network 102 in the one or more geographic regions (e.g., in one or more of Regions A and B, etc.). The divisions 114a-c may include programs or applications, which rely on the services 108a-j, whereby a hierarchy is defined (i.e., physical assets 104a-e, services 108a-j, divisions 114a-c). In this example embodiment, the divisions 114a-c include three divisions, but another number of divisions may be included in other embodiments.

The divisions 114a-c, like the services 108a-j, are also included in the service catalog 110 along with the indicated information about each of the divisions 114a-c.

As shown, the division 114a relies on services 108a and 108c, which are included in physical assets 104a and 104b, respectively. Also, the division 114b relies on services 108c, 108d, 108e, and 108f, which in turn, are executed at physical assets 104b, 104c and 104d. Finally, in FIG. 1, the division 114c relies on services 108b and 108g-j, which are executed on physical assets 104a, 104d and 104e.

It should be appreciated that the hierarchy of assets 104a-e, services 108a-j and divisions 114a-c described herein are for illustration only, and that various other hierarchies may be employed in other embodiments. In connection therewith, it should be appreciated that multiple layers of services may be employed in other system embodiments, as compared to the single layer of services 108a-j illustrated in FIG. 1, for example, where services, which support a division, rely on one or more other services, etc.

With that said, example services 108a-j may include, without limitation, authentication services, tokenization services, message switching services, or any combination of business services, etc. The services 108a-j, in turn, may be organized and/or offered as one or more divisions 114a-c, including, without limitation, business divisions and/or subsidiary legal entities (e.g., Human Resources, Finance, Operations, Market Product Line x, etc.).

It should be appreciated that, as compared to the physical assets 104a-e, the services 108a-j and the divisions 114a-c may be referred to here as virtual layer, as each is accessible through one or more networks, generally, without regard for a location of the physical assets 104a-e upon which the services 108a-j are being executed. It should also be appreciated that the number of divisions 114a-c, services 108a-j, and assets 104a-e are provided in this example for purposes of illustration. For various implementation, the assets 104a-e may include hundreds, thousands, or more, etc., physical assets, and the services 108a-j and divisions 114a-c may vary in number based on the type and/or function of the network or system into which they are included, etc.

It should also be appreciated that the physical assets 104a-e in the system 100 may be located in one or more geographic regions, which may be defined, for example, as cities, states, territories, countries, continents, or other natural, geopolitical, or governmental boundary, etc.

In the example embodiment of FIG. 1, two regions are delineated by boxes and designated Region A and Region B. The physical assets 104a-e, in turn, are included in the different Regions A, B. In particular, the assets 104a-b are located in Region A, and the assets 104c-e are located in Region B. In general, the assets 104a-e are located in one or more facilities operated by the processing network 102, such as, for example, an office building, data centers, server locations, etc.

In this example embodiment, as discussed above, the processing network 102 includes the host computing device 112, also referred to as host, which is configured to respond to queries related to the physical assets 104a-e, services 108a-j and divisions 114a-c of the processing network 102.

Initially, the host computing device 112 is configured to store, in memory thereof, certain data structures including, without limitation, the service catalog 110 and a site registry 116. The service catalog 110 includes a listing of the services 108a-j and the divisions 114a-c as explained above. Similarly, the site registry 116 includes a listing of the physical locations of facilities, data centers, etc. of the processing network 102. The site registry 118 includes, without limitation, street addresses, postal codes, countries, and also site codes, room codes, rack codes, aliases, etc. thereof. TABLE 1 illustrates an example partial view of the site registry 116, which demonstrates the mapping between the site code and the physical address/location.

TABLE 1

| Site Code | Physical Location |
|---|---|
| SERV_3268_CHI_1 | 200 Road Dr., Somewhere, IL |
| SERV_71350_CHI_2 | 200 Road Dr., Somewhere, IL |
| SERV_3666_SNG_17 | 20 Somewhere, Singapore |
| . . . | . . . |

It should be appreciated that the entries above are for purposes of illustration only and should not be understood to limit the scope of the present disclosure.

Also, the host computing device 112 is configured to store a configuration management database 118, which includes, without limitation, relevant information including configuration and inventory details about the hardware devices (physical and/or virtual), software, and software components utilized in connection with services 108a-j and divisions 114a-c of the processing network 102. Device details most commonly includes attribute, such as, for example: Manufacturer; Make; Model; Serial Number; IP, MAC or other Network addresses; Firmware and/or Operating System & Version; Installed Components or features; and/or Virtualization elements and configurations. Software details may include, for example: Publisher; Product; Version; Connections; Containers and Virtual Machines; Installation Details; Databases and/or Database Connectors; TLS Certificates and/or security configuration attributes.

The host computing device 112 is also configured to store, in the memory thereof, a virtual mapping data structure 120, which defines the hierarchy between the physical assets 104a-e, the services 108a-j and the divisions 114a-c. The virtual mapping data structure 120 may be defined through manual review, or through automated review of the processing network 102, generally starting through the OS of each physical assets 104. In addition, the mapping data structure 120 may further include inventory data for the assets 104a-e, including, without limitations, categories of hardware, software, and digital data (e.g., public keys, PKI inclusive cryptographic key materials, files, and configurations, etc.).

As it relates to the processing network 102, from time to time additional assets are added. In connection therewith, the additional assets are introduced into the data structures in the host computing device 112.

In particular, when the asset 104a, for example, is installed at a physical location in Region A (e.g., a data center, etc.), the installer (not shown) accesses the host computing device 112 in connection with the install. The host computing device 112 is configured to solicit the site code as physically written, inscribed, included, etc., on the asset 104a, from the tag 106. The installer scans, reads, and/or enters the site code and notes the physical location of the install. The physical location may include an address of the data center, as well as a rack code, room code, etc. In turn, the host computing device 112 is configured to enter the site code in the site registry 116 along with the physical address (and other desired data), to add the asset 104a to the configuration management database 118, and further to add any additional services (e.g., services 108a-b in this example, etc.), to be executed on the asset 104a, to the service catalog 110.

It should be appreciated that the site code and physical address may be previously entered into the site registry 116, prior to installation, based on an expected or directed installation of the asset at that location.

It should also be appreciated that assets 104a-e, services 108a-j and divisions 114a-c may be added to, or removed from, the processing network 102, whereby the data structures included in the host computing device 112 are updated accordingly, through input from technicians (e.g., installers, IT managers, etc.), which are responsible for modifying the processing network 102.

In connection therewith, the host computing device 112 is configured to identify the physical assets 104a-e of the processing network 102, and to identify the specific site codes of the physical assets 104a-e. The host computing device 112 is configured to append the appropriate site codes of the physical assets 104a-e in the management database 118 and to also inherit, based on the mapping data structure 120, the appropriate site codes to each of the services 108a-j being executed on the given physical assets 104a-e, and then to each of the divisions 114a-c that relies on the service(s) 108a-j. In this way, each of the assets 104a-e, services 108a-j and divisions 114a-c (outlined in the service catalog 110) is associated with one or more site codes (from sites contained in the site registry 116), related to these locations and then stored in the configuration management database 118.

Next, from time to time, reporting may be required for the processing network 102, including, specifically, regulatory reporting. In connection therewith, a request is provided to the host computing device 112 by a user, where the request is specific to one of the services 108a-j, one of the divisions 114a-c, one or more of the Regions A, B, policies, etc. In response to the request, the host computing device 112 is configured to access the service catalog 110, site registry 116, and the mapping data structure 120 and to compile a report consistent with the request.

That is, the host computing device 112 is configured to identify the physical location(s) of each of the assets 104a-e, by using the site codes in lookup through the site registry 116, then applying location(s) to the corresponding services 108a-j, and divisions 114a-c which are identified related to the assets 104a-e by way of the mapping module(s) (e.g., virtual mapping data structure 120, etc.).

In this way, the host computing device 112 may be configured to compile a report of all assets 104a-e, services 108a-j, and divisions 114a-c in a specific region, such as, for example, Region A. Or, the host computing device 112 may be configured to compile a report for one of the divisions 114a-c, which includes physical locations of the assets 104a-e and services 108a-j included therein. The report for the division 114a, for example, may be compiled to include assets 104a, b and services 108a, c in the specific region A. Based thereon, the host computing device 112 may be configured to compile a physical location therefrom for the division 114a, which is a list of the physical locations that the division 114a relies upon.

It should be appreciated that, through the physical locations being associated, via the site codes, with each of the assets 104a-e, services 108a-j, and divisions 114a-c, various different types of reports may be compiled by the host computing device 112.

Upon compilation, the host computing device 112 is configured to return the report to the user. The host computing device 112, for example, may be configured to display the report of the user at a computing device (e.g., via a user interface, application etc.), or to transmit (e.g., via email, web application programming interface (API), etc.) the report to the user for viewing apart from the host computing device 112.

FIG. 2 illustrates an example computing device 200 that can be used in the system 100. The computing device 200 may include, for example, one or more servers, workstations, personal computers, laptops, tablets, smartphones, etc. The computing device 200 may also include a single computing device, or it may include multiple computing devices located in close proximity or distributed over a geographic region, so long as the computing devices are specifically configured to function as described herein. In addition, while not illustrated, it should be appreciated that the processing network 102 may be implemented in, or associated with, at least one computing device consistent with computing device 200.

In the example embodiment of FIG. 1, each of the assets 104a-e and the host computing device 112 should be considered to be consistent, in whole or in part, with the computing device 200.

As shown, the example computing device 200 includes a processor 202 and a memory 204 coupled to the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 204, as described herein, is one or more devices that permit data, instructions, etc. to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, applications, application profiles, security aspects, interfaces, security standards, data clarifications, scores, indexes, and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiency and/or performance of the processor 202 that is scoring entities in connection with their preparedness for security attacks. It should be appreciated that the memory 204 may include a variety of different memories, each implemented in one or more of the functions or processes described herein.

In the example embodiment, the computing device 200 includes a presentation unit 206 that is coupled to the processor 202 (however, it should be appreciated that the computing device 200 could include output devices other than the presentation unit 206, etc.). The presentation unit 206 outputs information (e.g., asset reports by location, etc.), either visually or audibly to a user of the computing device 200. It should be further appreciated that various web-based interfaces (e.g., applications, webpages, etc.) may be displayed at computing device 200, and in particular at presentation unit 206, to display information to the user. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, indicating specifics of a report to be compiled (e.g., specific division, region, etc.), etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, behaves as both a presentation unit and an input device.

In addition, the illustrated computing device 200 also includes a network interface 210 coupled to the processor 202 and the memory 204. The network interface 210 may include, without limitation, a wired network adapter, a wireless network adapter, a mobile network adapter, or other device capable of communicating to one or more different networks, including the network 110. Further, in some example embodiments, the computing device 200 includes the processor 202 and one or more network interfaces incorporated into or with the processor 202.

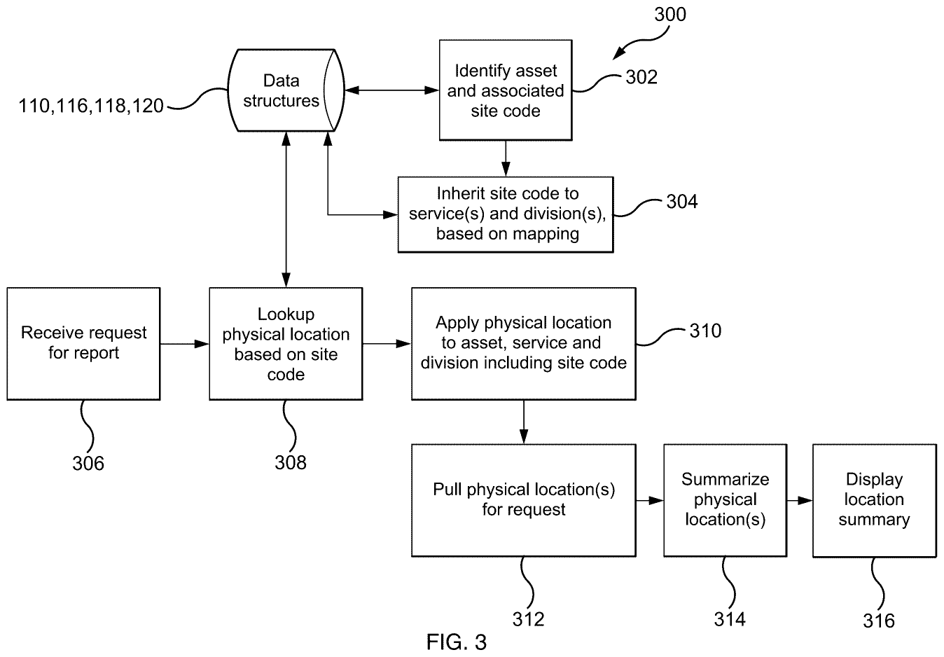

FIG. 3 illustrates an example method 300 for identifying assets to locations, based on site codes specific to physical assets, via site code registry. The example method 300 is described as implemented in the host computing device 112 of the system 100. Further, for purposes of illustration, the example method 300 is described herein with reference to the computing device 200. The methods herein should not be understood to be limited to the example system 100 or the example computing device 200, and likewise, the systems and the computing devices herein should not be understood to be limited to the example method 300.

At the outset, in method 300, the host computing device 112 is in communication with the data structures illustrated in FIG. 1, which include the service catalog 110, the site registry 116, the management database 118 and the mapping data structure 120.

With reference to FIG. 3, at 302, the host computing device 112 identifies an asset, such as, for example, the asset 104b and the site code associated with the asset 104b, from the site registry 116. In this example, the site code SERV_12654_STL_2 is included physically on the asset 104b, and listed in the site registry 116.

The host computing device 114 accesses the mapping data structure 120 and inherits, at 304, the site code for the asset 104b to each service and division, which relies on the asset 104b. As shown in FIG. 1, then, the site code SERV_12654_STL_2 is inherited to the services 108c and 108d, and also to the division 114a and the division 114b. The inheritance of the site code SERV_12654_STL_2 is appended to the management database 118.

In this way, the site code SERV_12654_STL_2 is inherited to the asset 104b, and the services 108c-d executed thereon, and the divisions 114a, b reliant on those services. Steps 302 and 304 are repeated for each of the assets 104a-e in the processing network 102, whereby each of the services 108a-j and each of the divisions 114a-c is associated with one or more site codes. This may be performed at one or more intervals, or at installation of new assets to the processing network 102.

As a result, the site codes for the assets 104b, 104c and 104d, for example, are each associated with the division 114b, while the site codes for the assets 104a, 104d and 104e are associated with the division 114c. At 310, the host computing device 112 applies physical locations to each of the assets 104a-e, services 108a-j and divisions 114a-c, associated with each of the site codes.

From time to time, reporting may be required to confirm regulatory compliance of the processing network 102. In connection therewith, a user compiles and submits a request. The request may include the identification of a service or a division, or combination thereof, or a region, etc. As shown in FIG. 3, the reporting request (e.g., on-demand or configured on a schedule, etc.) is received by the host computing device 112, at 306. The request may be configured with elections based on any combination of region, country, or other locality attribute for purposes of filtering the total data set. This leverages data structures 110, 116, 118, and 120. The request may be received as an input to an interface displayed by the host computing device 112, such as, for example, a webpage or application interface, etc. The interface may include a form for the request, whereby the user may select divisions, services, assets, regions, policies, etc.

When the request is specific to Region A, for example, upon receipt, the host computing device 112 searches, at 308, for the physical locations based on each of the site codes in the site registry 116 (broadly, in the host computing device 112) to determine a physical location and then, at 310, applies the physical location to the assets 104a-e, services 108a-j, and divisions 114a-c based on the site codes. At 312, the computing device 112 pulls the physical location for the request (e.g., potentially as applied at 310, etc.). The host computing device 112 may then identify the assets 104a-e, services 108a-j, and divisions 114a-c based on location of the same in Region A. The host computing device 112 may then summarize the physical locations of the assets 104a-e, at 314. The summary may include, for example, deduplication of location, so that a list of unique locations is available.

The host computing device 112 then displays the location summary to the user, at 316. Displaying may include displaying one or more interfaces, such as, for example, through the above devices, webpage, application, etc.

In some embodiments, the host computing device 112 may enable the display of such reports and/or summaries to the user, at 316, by way of a user Interface directly provided by the webpage or application. In other embodiments, the host computing device 112 may instead respond to an application programming interface (API) request with the data elements of the reports and/or summaries. In some embodiments, the API response may be included in, for example, JavaScript Object Notation (JSON) format for common data exchange and further system data consumption, etc.

When the request is specific to the division 114b, for example, upon receipt, the host computing device 112 identifies the site codes associated with the division 114b in the management database 118 and searches, at 308, for the physical location based on the site codes in the site registry 116. The host computing device 112 then, in this example, summarizes the physical locations, at 314, and displays, at 316, the location summary to the user.

It should be appreciated that the steps 310 and 312 may be omitted in the above example because the specific site codes are known from the request. It should also be appreciated that the use of the site codes to determine physical locations may proceed otherwise in other method embodiments, depending, for example, on what the request includes as criteria (e.g., asset, service, division, policy, etc.).

In view of the above, the systems and methods herein provide for identification of physical location(s) of physical assets, through site codes that are inherited at least to the services, and divisions.

In connection with IT asset regulatory reporting, the reporting may be associated with a combination of several key platforms, which may each be commercial, open source, internally developed or otherwise, etc. The platforms may be used in orchestration with each other in a specific manner to manage the infrastructure location data in conjunction with: the application and services of interest in a service catalog; a site registry including key metadata for the applications and services; an infrastructure/asset discovery solution (e.g., Application Discovery and Dependency Mapping (ADDM) solution (e.g., implemented to discover applications running on a network and document the same in context with supporting infrastructure and dependencies, etc.), etc.); and a configuration management database (e.g., standardized database, which may be relational and contains all relevant information about the IT resources (e.g., hardware, software, digital assets, etc.) and software components used in IT services, etc.). Based on the above, the reporting, even amongst the combination of platforms, is generated automatically and efficiently, through use of the site codes to identify physical locations, in response to any regulatory requirement involving selective scope from IT assets within the system.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a request, searching, by a host computing device, for a physical location based on multiple site codes implicated in the request; (b) summarizing, by the host computing device, the physical location for one or more of the sites codes; (c) displaying the physical location summary to a user; (d) identifying, by the host computing device, an asset of a network and a site code unique to the asset; (e) inheriting, by the host computing device, the site code for the asset to each of one or more services being executed on the asset; (f) inheriting the site code for the asset to each division, which relies on the one or more services; and/or (g) de-duplicating the physical locations associated with the multiple site codes.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” or “included with” another element or layer, it may be directly on, engaged, connected or coupled to, or associated with the other element or layer, or intervening elements or layers may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for identification of computer-based assets in connection with regulatory technologies, the method comprising:
in response to a request, searching, by a host computing device, for a physical location based on multiple site codes implicated in the request;
summarizing, by the host computing device, the physical location for one or more of the sites codes; and
displaying the physical location summary to a user.

2. The computer-implement method of claim 1, wherein the request is specific to a division; and
wherein searching for the physical location based on the multiple site codes includes searching based on the multiple site codes, which are specific to the division.

3. The computer-implement method of claim 1, further comprising:
identifying, by the host computing device, an asset of a network and a site code unique to the asset; and
inheriting, by the host computing device, the site code for the asset to each of one or more services being executed on the asset.

4. The computer-implement method of claim 3, further comprising inheriting the site code for the asset to each division, which relies on the one or more services.

5. The computer-implement method of claim 1, wherein summarizing the physical location includes de-duplicating the physical locations associated with the multiple site codes.

6. A non-transitory computer-readable storage medium including executable instructions for identification of computer-based assets in connection with regulatory technologies, which when executed by at least one processor, cause the at least one processor to:
in response to a request, search for a physical location based on multiple site codes implicated in the request;
summarize the physical location for one or more of the sites codes; and
display the physical location summary to a user.

7. The non-transitory computer-readable storage medium of claim 6, wherein the request is specific to a division; and
wherein the executable instructions, when executed by the at least one processor, cause the at least one processor, in searching for the physical location based on the multiple site codes, to search based on the multiple site codes, which are specific to the division.

8. The non-transitory computer-readable storage medium of claim 6, wherein the executable instructions, when executed by at least one processor, further cause the at least one processor to:
identify an asset of a network and a site code unique to the asset; and
inherit the site code for the asset to each of one or more services being executed on the asset.

9. The non-transitory computer-readable storage medium of claim 8, wherein the executable instructions, when executed by at least one processor, further cause the at least one processor to inherit the site code for the asset to each division, which relies on the one or more services.

10. The non-transitory computer-readable storage medium of claim 6, wherein the executable instructions, when executed by at least one processor, further cause the at least one processor, in summarizing the physical location, to de-duplicate the physical locations associated with the multiple site codes.

11. A system for identification of computer-based assets in connection with regulatory technologies, the system comprising:
a host computing device, which is configured to
in response to a request, search for a physical location based on multiple site codes implicated in the request;
summarize the physical location for one or more of the sites codes; and
display, at a presentation unit associated with the host computing device, the physical location summary to a user.

12. The system of claim 11, wherein the request is specific to a division; and
wherein the host computing device is configured, in searching for the physical location based on the multiple site codes, to search based on the multiple site codes, which are specific to the division.

13. The system of claim 11, wherein the host computing device is further configured to:
identify an asset of a network and a site code unique to the asset; and
inherit the site code for the asset to each of one or more services being executed on the asset.

14. The system of claim 13, wherein the host computing device is further configured to inherit the site code for the asset to each division, which relies on the one or more services.

15. The system of claim 11, wherein the host computing device is further configured, in summarizing the physical location, to de-duplicate the physical locations associated with the multiple site codes.
